(19) United States
(12) Patent Application Publication
(10) Pub. No.: US 2024/0346565 A1
(43) Pub. Date: Oct. 17, 2024

(54) Supermarket Payment System with Cloud-Based Customer Food Preference Verification

(71) Applicant: Kourosh Soroushian, San Diego, CA (US)

(72) Inventor: Kourosh Soroushian, San Diego, CA (US)

(73) Assignee: Kourosh Soroushian, San Diego, CA (US)

(21) Appl. No.: 18/135,189

(22) Filed: Apr. 17, 2023

(51) Int. Cl. G06Q 30/0601; G06Q 20/20; G06Q 20/32

(52) U.S. Cl. CPC G06Q 30/0629; G06Q 20/208; G06Q 20/325; G06Q 30/0631

(57) ABSTRACT

The present invention provides a supermarket payment system with cloud-based customer food preference verification. The system integrates customer food preferences into the payment process at a supermarket using cloud-based data storage. The system comprises a cash register, a cloud storage system, a communication module, a preference verification module, and an alert system. The cash register receives customer food preference information and scans food items. The cloud storage system stores food ingredients or categories, while the communication module establishes a secure connection between the cash register and the cloud storage system. The preference verification module compares scanned food items with the customer's indicated food preference, and the alert system provides alerts if a scanned item does not match the selected food category. Additionally, the alert system suggests alternative food items that comply with the customer's dietary preferences based on the supermarket's inventory.

### FIELD OF THE INVENTION

The present invention relates generally to supermarket payment systems and, more specifically, to a cloud-based system for verifying food items against a customer's indicated dietary preferences during the payment process in a supermarket. The invention integrates cloud-based data storage, food preference verification, and alert systems to enhance the customer's shopping experience and ensure that purchased food items align with their dietary preferences or restrictions.

### BACKGROUND

Supermarkets offer a wide variety of food items, which can pose challenges for customers with specific dietary preferences or restrictions. While some customers may be able to easily identify foods that match their dietary needs, others may struggle to distinguish non-compliant items from compliant ones. As a result, customers may unknowingly purchase foods that do not align with their dietary preferences, which can lead to negative health consequences and dissatisfied customers.

Various systems have been developed to address these challenges, such as providing dietary information on food labels, but these systems are not always effective. Customers may miss or misinterpret the information on the label, or they may not have enough time to read the labels while shopping. Therefore, there is a need for a system that can efficiently and accurately verify food items against a customer's dietary preferences.

### BRIEF DESCRIPTION OF THE DRAWINGS

FIG. 1 is a block diagram that illustrates the components of the Supermarket Payment System with Cloud-based Customer Food Preference Verification, showing a cash register, a cloud storage system, a communication module, a preference verification module, and an alert system.

FIG. 2 shows various input methods for obtaining customer food preference information, including buttons near the checkout area, verbal indicators, voice-recognition systems, mobile devices with Bluetooth connectivity, customer loyalty cards, smartphone applications, self-service kiosks, and online accounts associated with the supermarket.

FIG. 3 illustrates the cloud-based data storage system that includes the food category database and the food ingredient database, which store food categories and ingredients for each food item available in the supermarket.

FIG. 4 depicts the alert system that provides alerts in the form of visual indicators, voice alerts, or alert messages sent to the customer's phone via an application that communicates with the cash register.

### DETAILED DESCRIPTION

The present invention provides an innovative system and method for integrating customer food preferences into the payment process at a supermarket using cloud-based data storage. The system comprises a cash register, a cloud storage system, a communication module, a preference verification module, and an alert system. The cash register receives customer food preference information and scans food items. The cloud storage system stores food ingredients or categories, while the communication module establishes a secure connection between the cash register and the cloud storage system. The preference verification module compares scanned food items with the customer's indicated food preference, and the alert system provides alerts if a scanned item does not match the selected food category. Additionally, the alert system suggests alternative food items that comply with the customer's dietary preferences based on the supermarket's inventory.

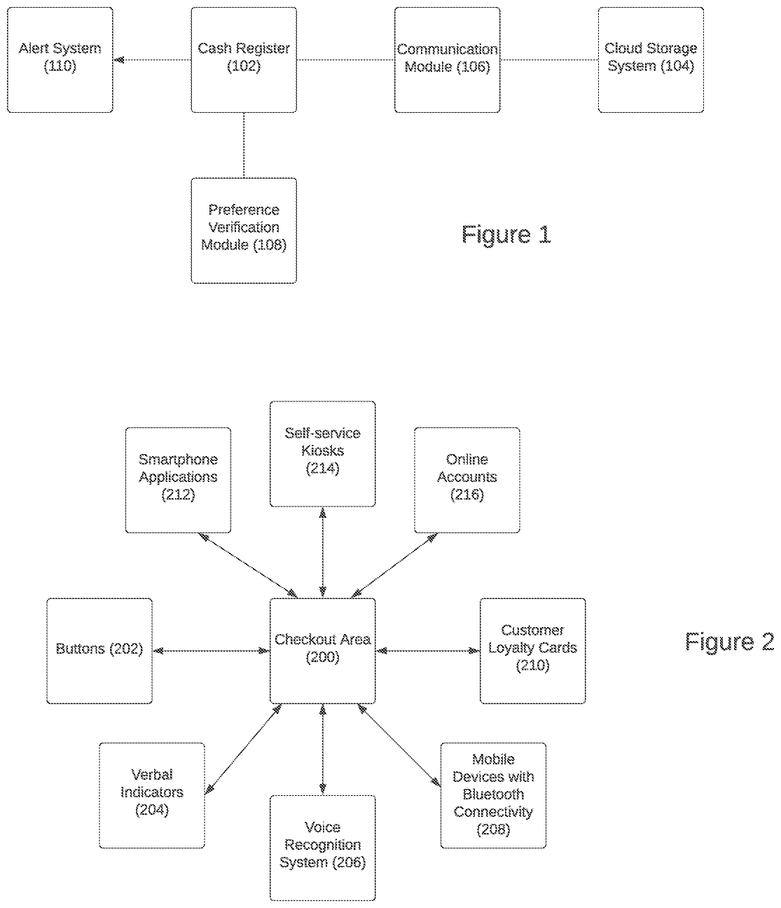

FIG. 1 is a block diagram that illustrates the components of the Supermarket Payment System with Cloud-based Customer Food Preference Verification. The figure shows a cash register 102, a cloud storage system 104, a communication module 106, a preference verification module 108, and an alert system 110. The cash register 102 is connected to the cloud storage system 104 via the communication module 106. The preference verification module 108 compares scanned food items with the customer's indicated food preference, and the alert system 110 provides alerts if a scanned item does not match the selected food category.

In one embodiment of the present invention, the cash register is a point-of-sale (POS) terminal that is used to scan food items and collect payment from customers. The cash register can be a stand-alone device or part of a larger system that includes other components, such as a customer display, a printer, and a payment processor.

In another embodiment, the customer food preference information is obtained through various input methods, such as buttons near the checkout area, verbal indicators, voice-recognition systems, mobile devices with Bluetooth connectivity, customer loyalty cards, smartphone applications, self-service kiosks, or online accounts associated with the supermarket. The customer food preference information can include various dietary preferences or restrictions, such as vegan, kosher, nut-free, and gluten-free.

FIG. 2 shows various input methods for obtaining customer food preference information. The figure shows buttons 202 near the checkout area 200, verbal indicators 204, voice-recognition systems 206, mobile devices with Bluetooth connectivity 208, customer loyalty cards 210, smartphone applications 212, self-service kiosks 214, and online accounts associated with the supermarket 216.

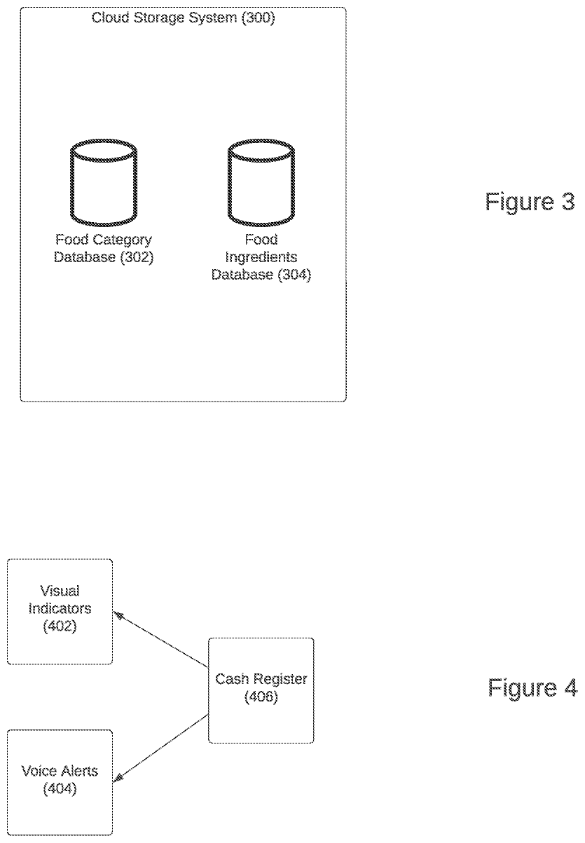

In another embodiment, the cloud storage system 300 stores food categories or ingredients for each food item available in the supermarket. The food category database 302 stores food categories, such as vegan, kosher, nut-free, and gluten-free, for each food item available in the supermarket. The food ingredient database 304 stores food ingredient information for each food item, including the presence or absence of common allergens or other dietary concerns. FIG. 3 shows the cloud-based data storage system that includes the food category database 302 and the food ingredient database 304.

In yet another embodiment, the alert system provides alerts in the form of visual indicators, such as lights or display messages, voice alerts, or alert messages sent to the customer's phone via an application that communicates with the cash register. Additionally, the alert system suggests alternative food items that comply with the customer's dietary preferences based on the supermarket's inventory. FIG. 4 shows the alert system that provides alerts in the form of visual indicators 402, voice alerts 404, or alert messages sent to the customer's phone via an application that communicates with the cash register 406.

The cloud storage system may include one or more databases containing tables designed to store food categories or ingredients for each food item available in the supermarket. Below is an example of a database table structure that can be used to store this information:
1. FoodItem Table:
   FoodItemID (Primary Key, Integer): A unique identifier for each food item in the supermarket.
   Name (Text): The name of the food item.
   Brand (Text): The brand or manufacturer of the food item.
   UPC (Text): The Universal Product Code or barcode associated with the food item.
2. FoodCategory Table:
   FoodCategoryID (Primary Key, Integer): A unique identifier for each food category, such as vegan, kosher, nut-free, and gluten-free.
   Name (Text): The name of the food category.
3. FoodIngredient Table:
   FoodIngredientID (Primary Key, Integer): A unique identifier for each food ingredient.
   Name (Text): The name of the food ingredient, such as wheat, soy, or peanuts.
4. FoodItemCategory Table:
   FoodItemID (Foreign Key, Integer): A reference to the FoodItem table, representing a specific food item.
   FoodCategoryID (Foreign Key, Integer): A reference to the FoodCategory table, representing a specific food category.
   IsCompliant (Boolean): A flag indicating whether the food item complies with the specified food category (true) or not (false).
5. FoodItemIngredient Table:
   FoodItemID (Foreign Key, Integer): A reference to the FoodItem table, representing a specific food item.
   FoodIngredientID (Foreign Key, Integer): A reference to the FoodIngredient table, representing a specific food ingredient.
   Quantity (Float): The quantity of the ingredient present in the food item, if applicable.
   Unit (Text): The unit of measurement for the quantity of the ingredient, such as grams, milligrams, or percentage.

The tables in the cloud storage system can be designed to store food categories or ingredients for each food item available in the supermarket, allowing for the efficient comparison of scanned food items against the customer's indicated dietary preferences. The database structure described above is just one example of how the cloud storage system could be organized, and other structures could be implemented depending on specific requirements and constraints.

The Supermarket Payment System with Cloud-based Customer Food Preference Verification offers several advantages over existing systems. The system enables customers to indicate their dietary preferences conveniently and efficiently, without requiring extensive label reading or research. Additionally, the system provides customers with alerts if a scanned item does not match the selected food category, reducing the risk of purchasing non-compliant items. The alert system also suggests alternative food items that comply with the customer's dietary preferences, enhancing customer satisfaction and loyalty.

### SUMMARY OF THE INVENTION

In one aspect, the present invention provides a method for verifying food items against a customer's indicated dietary preferences in a supermarket. The method includes receiving the customer's indicated dietary preferences through various input methods, scanning food items at a cash register, establishing a secure connection between the cash register and a cloud storage system, comparing the scanned food items with the customer's indicated food preference, and providing an alert if a scanned item does not match the selected food category. In some embodiments, the method further includes suggesting alternative food items that comply with the customer's dietary preferences based on the supermarket's inventory.

In another aspect, the invention provides a system for verifying food items against a customer's indicated dietary preferences in a supermarket. The system includes a cash register, a cloud storage system, a secure communication link, a processor, and an alert system. The cash register receives the customer's dietary preferences and scans food items. The cloud storage system stores food categories or ingredients for each food item available in the supermarket. The processor compares the scanned food items with the customer's indicated food preference stored in the cloud storage system, and the alert system provides an alert if a scanned item does not match the selected food category. In some embodiments, the system further includes a suggestion system for providing alternative food items that comply with the customer's dietary preferences based on the supermarket's inventory.

These embodiments of the present invention aim to streamline the supermarket shopping experience for customers with specific dietary preferences or restrictions. By integrating food preference verification into the payment process, the invention provides a convenient and efficient way for customers to ensure their purchases align with their dietary preferences. The alert system helps customers avoid purchasing non-compliant items, while the suggestion system offers alternative food items that comply with their preferences.

Various input methods can be used to obtain the customer's indicated food preference, such as buttons near the checkout area, verbal indicators, voice-recognition systems, mobile devices with Bluetooth connectivity, customer loyalty cards, smartphone applications, self-service kiosks, or online accounts associated with the supermarket.

The secure connection between the cash register and the cloud storage system can be established using different communication protocols, including Wi-Fi, Bluetooth, or cellular networks. This flexibility allows for the system to be implemented in a wide range of supermarket environments and adapt to the available communication infrastructure.

In summary, the present invention provides an innovative solution to the challenges faced by customers with specific dietary preferences or restrictions in supermarkets. The method and system for verifying food items against a customer's indicated dietary preferences offer a convenient and efficient way for customers to ensure their food purchases match their preferences. The alert and suggestion systems further enhance customer satisfaction and loyalty by helping them avoid non-compliant items and offering suitable alternatives.

### CONCLUSION

The Supermarket Payment System with Cloud-based Customer Food Preference Verification provides an innovative solution to the challenges of verifying food items against a customer's dietary preferences in a supermarket. By integrating cloud-based data storage with the payment process, the system offers a convenient and efficient way for customers to indicate their food preferences and for the supermarket to verify food items against those preferences. The system also offers suggestions for alternative food items that comply with the customer's dietary preferences, enhancing customer satisfaction and loyalty. The system can be implemented using a variety of input methods, such as buttons, voice recognition, mobile devices, or online accounts, and is compatible with various communication protocols to ensure secure data transmission. The Supermarket Payment System with Cloud-based Customer Food Preference Verification offers a valuable contribution to the field of supermarket payment systems and has the potential to improve the shopping experience for millions of customers worldwide.

1. A method for verifying food items against a customer's indicated dietary preferences in a supermarket, comprising:
receiving the customer's indicated dietary preferences through various input methods;
scanning food items at a cash register;
establishing a secure connection between the cash register and a cloud storage system that stores food categories or ingredients for each food item available in the supermarket;
comparing the scanned food items with the customer's indicated food preference stored in the cloud storage system;
providing an alert if a scanned item does not match the selected food category.

2. The method of claim 1, wherein the alert is provided in the form of a visual indicator, voice alert, or alert message sent to the customer's phone via an application that communicates with the cash register.

3. The method of claim 1, wherein the cloud storage system stores food categories or ingredients for each food item available in the supermarket, and the comparison is based on the stored food categories or ingredients.

4. The method of claim 1, wherein the establishment of a secure connection between the cash register and the cloud storage system uses various communication protocols, including Wi-Fi, Bluetooth, or cellular networks.

5. The method of claim 1, further comprising suggesting alternative food items that comply with the customer's dietary preferences based on the supermarket's inventory, and the suggestions are based on the food categories or ingredients stored in the cloud storage system.

6. The method of claim 1, further comprising collecting payment from the customer at the cash register after scanning and verifying the food items against the customer's indicated dietary preferences.

7. The method of claim 1, wherein the various input methods for obtaining the customer's indicated food preference include at least one of the following: buttons near the checkout area, verbal indicators to the cashier, a voice-recognition system, a mobile device with Bluetooth connectivity with the cash register, a customer loyalty card associated with the supermarket, a smartphone application, a self-service kiosk, and an online account associated with the supermarket.

8. A system for verifying food items against a customer's indicated dietary preferences in a supermarket, comprising:
a cash register configured to scan food items and receive the customer's indicated dietary preferences through various input methods;
a cloud storage system that stores food categories or ingredients for each food item available in the supermarket;
a secure communication link between the cash register and the cloud storage system to establish a connection and transmit data;
a processor configured to compare the scanned food items with the customer's indicated food preference stored in the cloud storage system; and
an alert system configured to provide an alert if a scanned item does not match the selected food category.

9. The system of claim 8, wherein the alert system provides an alert in the form of a visual indicator, voice alert, or alert message sent to the customer's phone via an application that communicates with the cash register.

10. The system of claim 8, wherein the cloud storage system stores food categories or ingredients for each food item available in the supermarket, and the comparison is based on the stored food categories or ingredients.

11. The system of claim 8, wherein the secure communication link between the cash register and the cloud storage system uses various communication protocols, including Wi-Fi, Bluetooth, or cellular networks.

12. The system of claim 8, further comprising a suggestion system configured to suggest alternative food items that comply with the customer's dietary preferences based on the supermarket's inventory, and the suggestions are based on the food categories or ingredients stored in the cloud storage system.

13. The system of claim 8, further comprising a payment system configured to collect payment from the customer at the cash register after scanning and verifying the food items against the customer's indicated dietary preferences.

14. The system of claim 8, wherein the various input methods for obtaining the customer's indicated food preference include at least one of the following: buttons near the checkout area, verbal indicators to the cashier, a voice-recognition system, a mobile device with Bluetooth connectivity with the cash register, a customer loyalty card associated with the supermarket, a smartphone application, a self-service kiosk, and an online account associated with the supermarket.

15. The method of claim 7, wherein the input methods further comprise a combination of multiple input methods.

16. The system of claim 14, wherein the input methods further comprise a combination of multiple input methods.

17. The method of claim 1, wherein the customer's dietary preferences include at least one of the following: vegan, vegetarian, kosher, halal, nut-free, gluten-free, lactose-free, or low-sodium.

18. The system of claim 8, wherein the customer's dietary preferences include at least one of the following: vegan, vegetarian, kosher, halal, nut-free, gluten-free, lactose-free, or low-sodium.

19. The method of claim 5, wherein the suggested alternative food items are ranked based on relevance to the customer's dietary preferences and availability in the supermarket's inventory.

20. The system of claim 12, wherein the suggested alternative food items are ranked based on relevance to the customer's dietary preferences and availability in the supermarket's inventory.
